(19) United States
(12) Patent Application Publication
(10) Pub. No.: US 2018/0014472 A1
(43) Pub. Date: Jan. 18, 2018

(54) SHELL PLANTER FOR GROWER'S PLANTER

(71) Applicant: ATT Southern, Inc., Camp Hill, PA (US)

(72) Inventors: Patrick Saunders GUILLORY, Smyrna, GA (US); Chun HUNG, Dillsburg, PA (US); Daniel VAN ROSSEN, II, Cornelius, NC (US); Brian K. LEAHY, Atlanta, GA (US)

(21) Appl. No.: 15/210,317

(22) Filed: Jul. 14, 2016

(51) Int. Cl. A01G 9/10; A01G 9/02

(52) U.S. Cl. CPC A01G 9/104; A01G 9/02

(57) ABSTRACT

A planter assembly is provided. The planter assembly includes a grower planter and a shell planter. The grower planter includes an upper distal end. The grower planter includes an upper distal end. The shell planter is structured to enclose said grower planter. That is, when the grower planter is disposed in the shell planter, the grower planter distal end is disposed subjacent to the shell planter distal end. Further, in an exemplary arrangement, a shell planter body sidewall distal end subjacent, inner surface is sized relative to the grower planter body sidewall distal end maximum cross-sectional area to be one of a corresponding size, a closely corresponding size, or a snuggly corresponding size.

### TECHNICAL FIELD

The disclosed and claimed concept generally relates to a planter assembly and, more specifically, to a planter assembly that includes a shell planter structured to conceal a grower planter therein.

### BACKGROUND

Growers, as used herein, are businesses that plant seeds and/or cuttings and which care for a young plant. When the plant reaches a selected size and/or age, the grower sells the plant. Growers use planters that are of a standard size, are inexpensive, and which are not intended to be a permanent planter for the plant. Thus, as used herein, a “grower planter” is a planter having a selected standard size, a body having a thickness of between about 0.25 mm and 1.50 mm, and which is sold with a plant and soil disposed therein. A “grower planter” selected standard size is selected from the group consisting of about 0.75 gal., about 1.5 gal, or about 2.45 to 2.88 gal. planter. Such grower planters are intended for temporary use. That is, a purchaser of the plant in a grower planter is expected to transplant the plant, along with a quantity of the soil, in a more robust decorative planter or in the ground. That is, a “decorative planter,” as used herein, is a planter with a body having a thickness of between about 1.0 and 2.0 mm.

Users, however, are sometimes reluctant to transplant the plant. Such users often place the plant in the grower planter into a decorative planter. Decorative planters, however, are not structured to have a grower planter disposed therein in a concealed manner. That is, decorative planters are often the same volume as the grower planter and, as is known, both grower planters and decorative planters have a tapered sidewall. In this configuration, and when a user places a grower planter in a decorative planter, the upper, distal end of the grower planter would rise above the upper, distal end of the decorative planter. This configuration is unsightly in that the inexpensive grower planter is visible.

Alternatively, the user could use a decorative planter that was larger than the grower planter. In this configuration, the sidewall of the grower planter was often spaced from the sidewall of the decorative planter and/or the upper, distal end of the grower planter was disposed well below the upper, distal end of the decorative planter. When the user filled the decorative planter with additional soil, so as to conceal the difference in the sizes of the grower planter and the decorative planter, the plant could be partially buried in the new soil.

Further, as grower planters are inexpensive, grower planters do not include stand-off features structured to space the bottom of the grower planter from the bottom of the decorative planter. This is a problem because the grower planter could seal the drain openings of the decorative planter thereby allowing water to pool in the planter assembly.

There is, therefore, a need for an improved planter assembly that addresses these disadvantages.

### SUMMARY

The disclosed and claimed concept addresses these disadvantages by providing a planter assembly including a grower planter and a shell planter. The grower planter includes an upper distal end. The shell planter includes an upper distal end. The shell planter is structured to enclose said grower planter. That is, when the grower planter is disposed in the shell planter, the grower planter distal end is disposed subjacent to the shell planter distal end. Further, in an exemplary embodiment, a shell planter body sidewall distal end subjacent, inner surface is sized relative to the grower planter body sidewall distal end maximum cross-sectional area to be one of a corresponding size, a closely corresponding size, or a snuggly corresponding size.

In this configuration, the shell planter conceals the grower planter. That is, the shape, size, and configuration of the shell planter relative to the grower planter, and/or the configuration of the planter assembly, including the configuration wherein the grower planter body sidewall distal end is disposed subjacent to the shell planter body sidewall distal end, solves the problems stated above.

### BRIEF DESCRIPTION OF THE DRAWINGS

A full understanding of the disclosure can be gained from the following description of the exemplary embodiments when read in conjunction with the accompanying drawings in which:

FIG. 1 is an isometric view of one exemplary arrangement of a planter assembly.

FIG. 2 is a side view of one exemplary arrangement of a planter assembly.

FIG. 3 is a cross-sectional side view of one exemplary arrangement of a planter assembly. FIG. 3A is a detail cross-sectional side view of one exemplary arrangement of a planter assembly.

FIG. 4 is another isometric view of one exemplary arrangement of a planter assembly.

FIG. 5 is a cross-sectional side view of another exemplary arrangement of a planter assembly. FIG. 5A is a detail side view of another exemplary arrangement of a planter assembly.

FIG. 6 is a side view of another exemplary arrangement of a planter assembly.

### DETAILED DESCRIPTION

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, “temporarily coupled” means that two components are coupled in a manner that allows for the components to be easily decoupled without damaging the components.

As used herein, the statement that two or more parts or components “engage” one another shall mean that the elements exert a force or bias against one another either directly or through one or more intermediate elements or components.

As used herein, the word “unitary” means a component is created as a single piece or unit. That is, a component that includes pieces that are created separately and then coupled together as a unit is not a “unitary” component or body.

As used herein, the term “number” shall mean one or an integer greater than one (i.e., a plurality).

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut.

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are said to “closely correspond.” As used herein, “closely correspond” means that the members contact each other at a number of locations. That is, an opening that “closely corresponds” to a member means that the opening and the member have substantially the same cross-sectional area. This definition is also modified if the two components are said to fit “snugly” together or “snuggly correspond.” In that situation, the member being disposed in the opening is compressible or deformable and has a cross-sectional area that is the same cross-sectional area as the opening, or even slightly larger. Alternately, the element defining the opening may be made from a deformable or compressible material. Further, as used herein, “loosely correspond” means that a slot or opening is sized to be larger than an element disposed therein. This means that the increased size of the slot or opening is intentional and is more than a manufacturing tolerance. Further, with regard to a surface formed by two or more elements, a “corresponding” shape means that surface features, e.g., curvature, are similar.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb or “be an [X]”]” recites structure and not function. Further, as used herein, “structured to [verb or “be an [X]”]” means that the identified element or assembly is intended to, and is designed to, perform the identified verb or to be an [X]. Thus, an element that is only possibly “capable” of performing the identified verb but which is not intended to, and is not designed to, perform the identified verb is not “structured to [verb or “be an [X]”].”

As used herein, “at” means on or near.

As used herein, “nesting” or “nested” means that two hollow bodies having a similar shape are disposed with one body substantially inside the other body. Thus, a planter disposed in a basin, wherein the basin is substantially more shallow than the planter, is not “nested” as the planter is not disposed substantially inside the basin.

As used herein, “nesting planters” means a set of planters having a substantially similar shape. It is understood that different sets of nesting planters may have different shapes. Thus, for example, there may be a set of circular nesting planters and a set of rectangular nesting planters. It is understood that when nesting planters are described as nesting in each other, disposed in each other, etc., it means that the nesting planters are from one set, i.e., the nesting planters have a substantially similar shape.

As used herein, “subjacent” means parallel to an identified construct, or, up to about 8 mm below the identified construct.

As used herein, “proximately subjacent” means parallel to an identified construct, or, up to about 5 mm below the identified construct.

As used herein, “immediately subjacent” means parallel to an identified construct, or, up to about 2 mm below the identified construct.

As used herein, a “shell planter” is structured to enclose a grower planter and is a decorative planter.

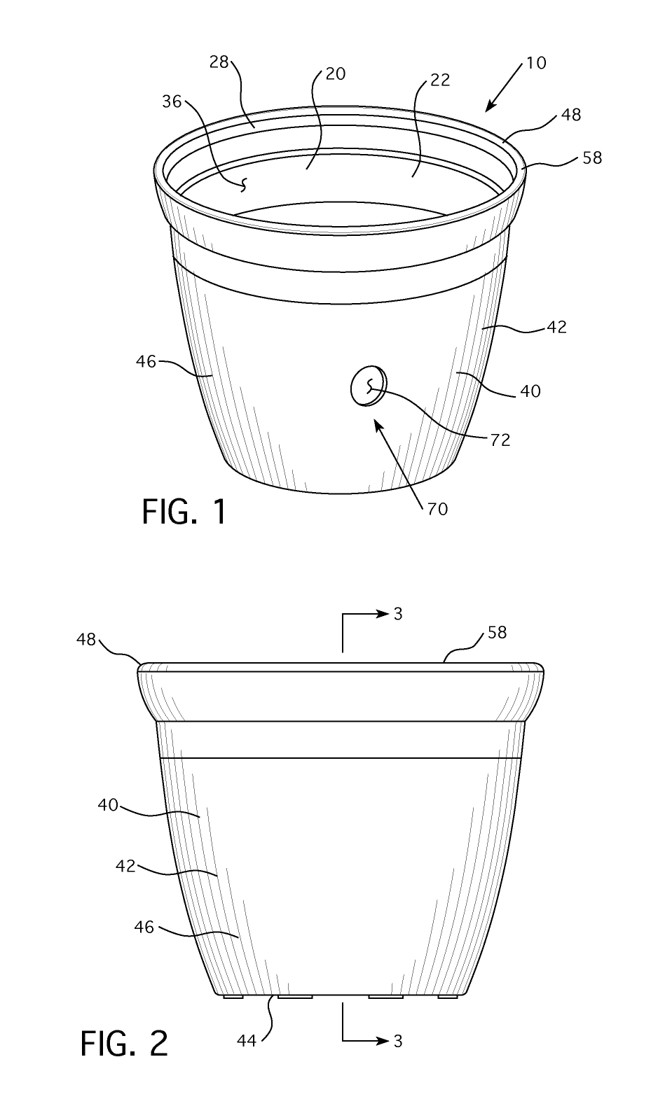

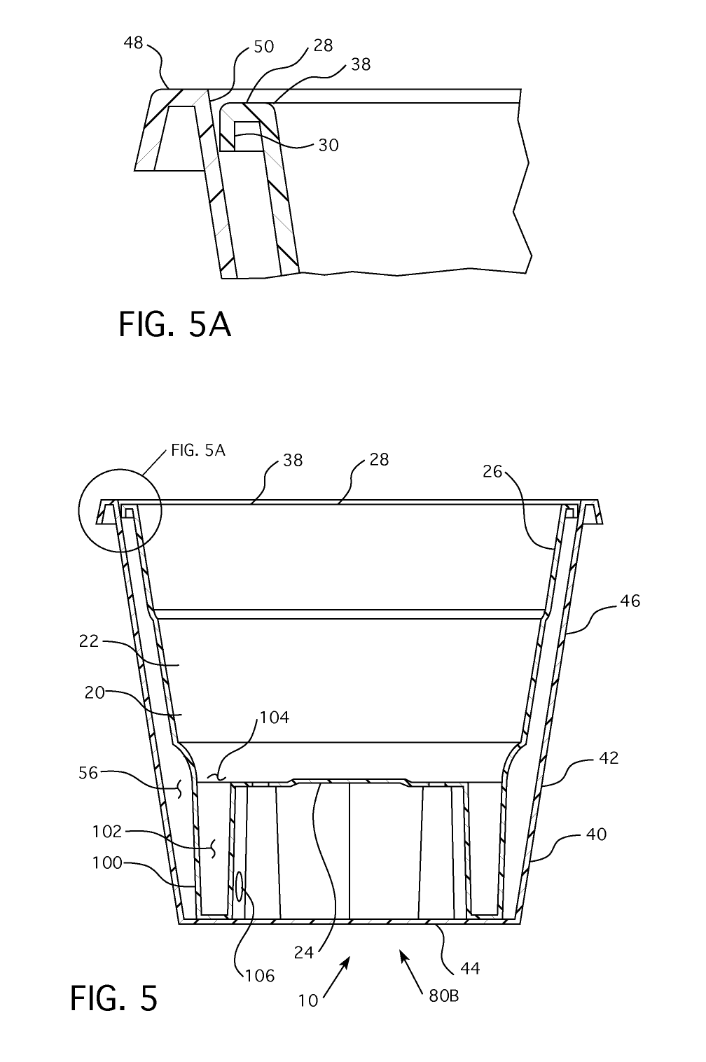

As shown in FIGS. 1 and 5, a planter assembly 10 includes a grower planter 20 and a shell planter 40. In the Figures and in an exemplary arrangement, the grower planter 20 and the shell planter 40 are shown as having a generally circular cross-sectional shape. This shape is exemplary only and the grower planter 20 and the shell planter 40 may have any cross-sectional shape.

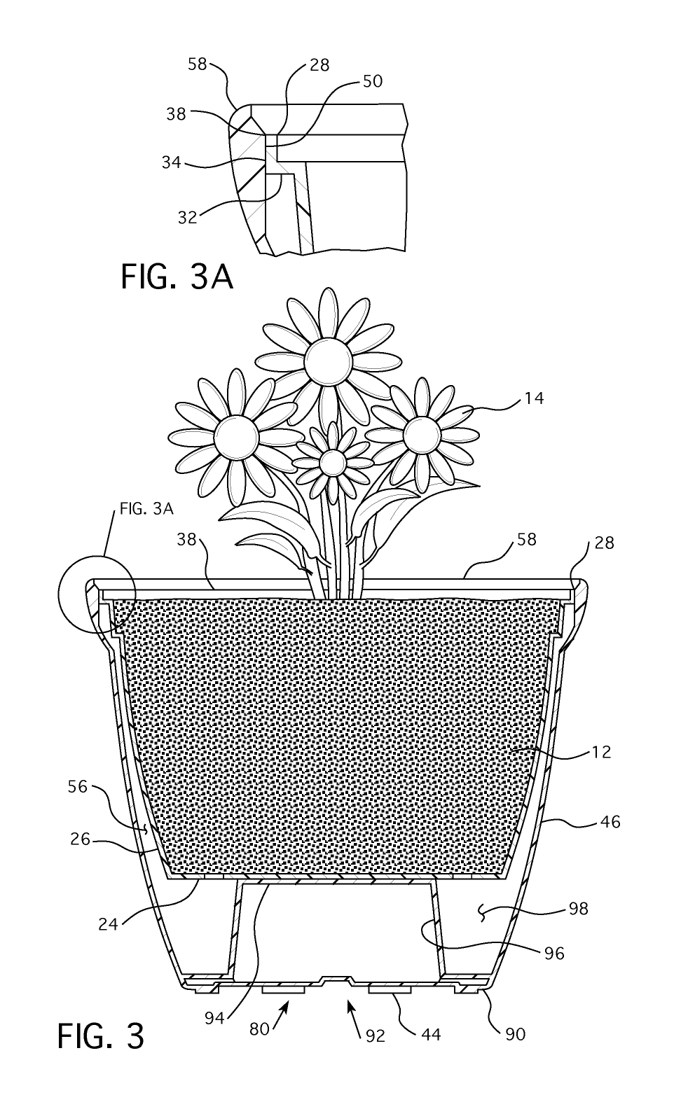

The grower planter 20 includes a body 22 having a base member 24 and an ascending and depending sidewall 26. In an exemplary embodiment, the grower planter body 22 is a unitary body. Further, as used herein, “depending” means “extending from.” In an exemplary embodiment, the grower planter body 22, i.e., the base member 24 and the sidewall 26, have generally the same thickness which is between about 0.25 mm and 1.0 mm, or about 0.6 mm. In an exemplary embodiment, the grower planter body base member 24 is generally planar and may include passages (not shown) there through. In an exemplary arrangement, the grower planter body sidewall 26 tapers outward from the periphery of the grower planter body base member 24. Thus, the grower planter body sidewall 26 includes a distal end 28 which is the widest portion, i.e., the greatest cross-sectional area, of the grower planter body 22. In an exemplary embodiment, the grower planter body sidewall distal end 28 may include a downward curl 30, as shown in FIG. 5A, or, a peripheral flange 32 and upwardly extending rim 34, as shown in FIG. 3A. It is understood that the “maximum cross-sectional area,” as used herein, occurs at the grower planter body sidewall distal end 28 and at the outer side thereof. In another embodiment, not shown, the grower planter body 22 includes a thicker portion of the grower planter body sidewall 26 at the grower planter body sidewall distal end 28. Further, it is noted that the grower planter body sidewall distal end 28 is coextensive with a grower planter body distal end 38. In this configuration, the grower planter body 22 defines an enclosed space 36 that is generally open at the grower planter body distal end 38. As is known, a quantity of soil 12 and a plant 14 are, in an exemplary embodiment, disposed in the grower planter body enclosed space 36.

The shell planter 40 includes a body 42 having a base member 44 and an ascending and depending sidewall 46. In an exemplary embodiment, the shell planter body 42 is a unitary body. In an exemplary embodiment, the shell planter body sidewall 46 tapers outward from the periphery of the shell planter body base member 44. Thus, the shell planter body sidewall 46 includes a distal end 48 which is the widest portion, i.e., the greatest cross-sectional area, of the shell planter body 42. Further, the shell planter body sidewall 46 includes an inner surface just below the shell planter body sidewall distal end 48 hereinafter identified as the shell planter body sidewall distal end subjacent, inner surface 50. This surface, identified as the shell planter body sidewall distal end subjacent, inner surface 50, is disposed immediately adjacent, or in contact with, the grower planter body sidewall distal end 28 when the grower planter 20 is disposed within the shell planter 40. Further, it is noted that the shell planter body sidewall distal end 48 is coextensive with a shell planter body distal end 58. In this configuration, the shell planter body 42 defines an enclosed space 56 that is generally open at the shell planter body distal end 58.

The shell planter 40 is structured to enclose the grower planter 20. Stated alternately, the grower planter 20 is structured to be nested in the shell planter 40 with the grower planter distal end 38 disposed subjacent to the shell planter distal end 58. In this configuration, the shell planter 40 is structured to conceal the grower planter 20 in a manner such that a user will not be able to easily detect that the grower planter 20 and the shell planter 40 are separate constructs. For example, when viewed from the side, i.e., generally horizontally at an elevation even with or below shell planter body distal end 58, the grower planter 20 is not visible while also ensuring the grower planter body sidewall distal end 28 and the shell planter body sidewall distal end subjacent, inner surface 50 are about the same size, as discussed below. This is accomplished by having the grower planter distal end 38 disposed subjacent to the shell planter distal end 58 when the grower planter 20 is disposed within the shell planter body enclosed space 56. Further, in other exemplary embodiments, the grower planter distal end 38 is disposed proximately subjacent, or disposed immediately subjacent, to the shell planter distal end 58 when the grower planter 20 is disposed within the shell planter body enclosed space 56. These configurations solve the problems stated above. Stated alternately, when the grower planter body 22 is disposed in the shell planter body 42, the grower planter body sidewall distal end 28 is disposed subjacent to the shell planter body sidewall distal end 48. In alternate embodiments, when the grower planter body 22 is disposed in the shell planter body 42, the grower planter body sidewall distal end 28 is disposed proximately subjacent, or disposed immediately subjacent, to the shell planter body sidewall distal end 48.

Further, in an exemplary arrangement, the shell planter body sidewall distal end subjacent, inner surface 50 (FIGS. 3A, 5A) is sized relative to the maximum cross-sectional area of the grower planter body sidewall distal end 28 to be one of a corresponding size, a closely corresponding size, or a snuggly corresponding size. In this configuration, there is a minimal gap, a small gap, or no gap, between the shell planter body sidewall distal end subjacent, inner surface 50 and the maximum cross-sectional area of the grower planter body sidewall distal end 28. As used herein, a “small gap” is a gap having the same thickness as the grower planter body sidewall 26.

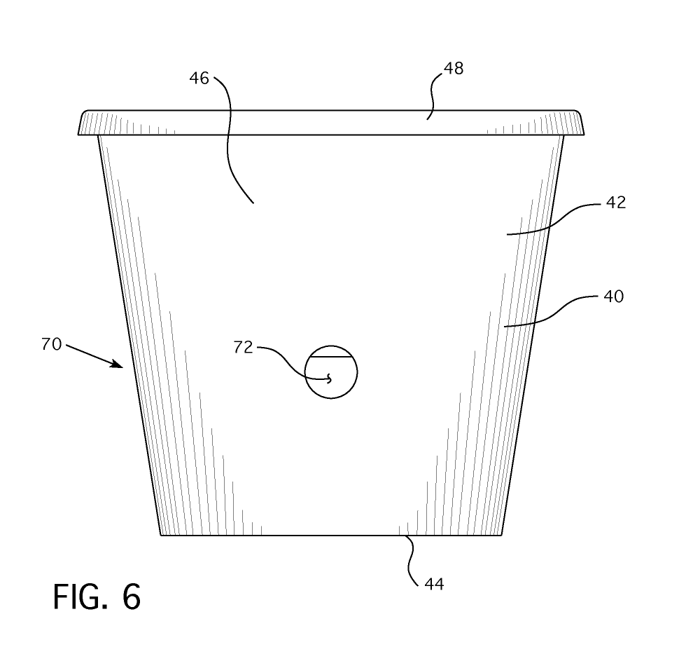

In an exemplary embodiment, the planter assembly 10 includes a watering assembly 70, FIGS. 1 and 6. The watering assembly 70 includes a watering aperture 72 and a stand-off feature 80. The watering aperture 72 is disposed in the shell planter body sidewall 46 and is discussed in more detail below. The watering aperture 72 may be described as a “shell planter body sidewall watering aperture 72.”

The stand-off feature 80 is structured to space the grower planter body base member 24 above the shell planter body base member 44. The stand-off feature 80 may be part of either, or both, the grower planter 20 or the shell planter 40. Stated alternately, one of the shell planter body base member 44 or the grower planter body base member 24 includes a stand-off feature 80, or, both the shell planter body base member 44 and the grower planter body base member 24 include cooperative stand-off features (not shown).

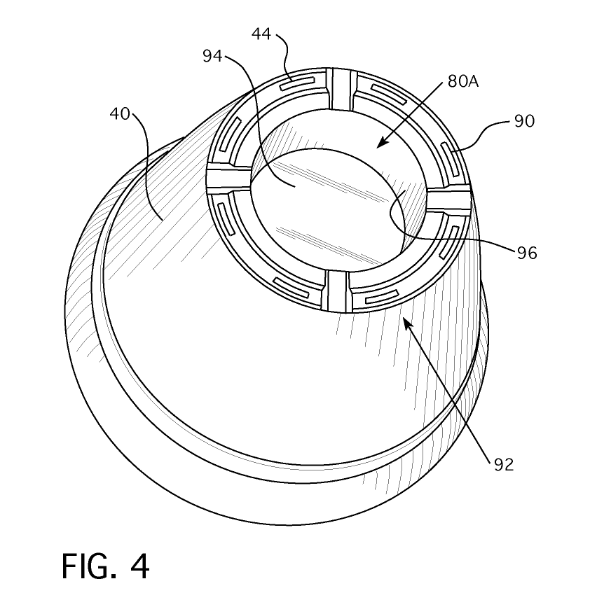

In one exemplary arrangement, FIGS. 3 and 4, the stand-off feature 80 is unitary with the shell planter 40. That is, the stand-off feature 80 is a “shell planter body stand-off feature” 80A. In this embodiment, the shell planter body base member 44 includes a generally planar portion 90. In an exemplary embodiment, the shell planter body base member planar portion 90 extends along the periphery of the shell planter body base member 44. In this embodiment, the stand-off feature 80 is unitary with the shell planter body base member 44 and includes a platform 92. In an exemplary embodiment, the platform 92 is disposed centrally over the shell planter body base member 44. Stated alternately, the shell planter body base member planar portion 90 extends about, i.e., around, the platform 92. The platform 92 includes a planar portion 94 and a depending sidewall 96. The platform sidewall 96 extends between the shell planter body base member planar portion 90 and the platform planar portion 94. In this configuration, the shell planter body sidewall 46, the shell planter body base member planar portion 90, and the platform sidewall 96 define an annulus 98. Further, the shell planter body stand-off feature 80A is structured to support the grower planter body 22 above the shell planter body base member planar portion 90. Thus, water may pool in, and extend above, the annulus 98. Thus, water is in fluid communication with the passages in the grower planter body base member 24.

Further, in an exemplary arrangement, the shell planter body sidewall 46 includes a watering aperture 72 disposed above the platform 92. That is, the watering aperture 72 is disposed superjacent, i.e., just above, the platform 92 so that the water level in the annulus 98 does not rise substantially above the grower planter body base member 24 (which rest upon the platform 92).

In another arrangement, FIG. 5, the stand-off feature 80 is unitary with the grower planter 20. That is, the stand-off feature 80 is a “grower planter body stand-off feature” 80B. In this embodiment, the grower planter body stand-off feature 80B includes a number of hollow legs 100 extending downwardly from the grower planter base member 24. Each hollow leg 100 defines a conduit 102. Each hollow leg conduit 102 is in fluid communication with the grower planter body enclosed space 36. That is, in an exemplary arrangement, the grower planter base member 24 defines an opening 104 at each hollow leg 100. Further, each hollow leg 100 includes a passage 106. Each hollow leg passage 106 allows water to pass from outside the hollow leg 100 to the hollow leg conduit 102. The hollow legs 100 support the grower planter base member 24 above the shell planter body base member 44. In this arrangement, water pools in the space between the grower planter base member 24 and the shell planter body base member 44. Water passes through a leg passage 106 and is communicated via hollow leg conduit 102 to the grower planter body enclosed space 36.

Further, in an exemplary arrangement, the shell planter body sidewall 46 includes a watering aperture 72 disposed above the grower planter base member 24. That is, the watering aperture 72 is disposed superjacent, i.e., just above, the grower planter base member 24 so that water level does not rise substantially above the grower planter body base member 24.

While specific exemplary arrangements of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosure which is to be given the full breadth of the claims appended and any and all equivalents thereof.

What is claimed is:

1. A shell planter for a grower planter, said grower planter including a body with a base member and an upwardly depending sidewall, said grower planter body defining an enclosed space, said grower planter body sidewall including a distal end, said shell planter comprising:
a body including a base member and an upwardly depending sidewall;
said shell planter body sidewall including a distal end;
said shell planter body structured to enclose said grower planter body; and
wherein, when said grower planter body is disposed in said shell planter body, said grower planter body sidewall distal end is disposed subjacent to said shell planter body sidewall distal end.

2. The shell planter of claim 1 wherein when, said grower planter body is disposed in said shell planter body, said grower planter body sidewall distal end is disposed proximately subjacent to said shell planter body sidewall distal end.

3. The shell planter of claim 1 wherein when, said grower planter body is disposed in said shell planter body, said grower planter body sidewall distal end is disposed immediately subjacent to said shell planter body sidewall distal end.

4. The shell planter of claim 1 wherein said grower planter body sidewall is tapered and said grower planter body sidewall distal end has a maximum cross-sectional area, and wherein:
said shell planter body sidewall is tapered, wherein said shell planter body sidewall distal end has a, subjacent, inner surface; and
wherein said shell planter body sidewall distal end subjacent, inner surface is sized relative to said grower planter body sidewall distal end maximum cross-sectional area to be one of a corresponding size, a closely corresponding size, or a snuggly corresponding size.

5. The shell planter of claim 1 wherein:
said shell planter body base member includes a generally planar portion and a stand-off feature; and
wherein said shell planter body stand-off feature is structured to support said grower planter body above said shell planter body base member planar portion.

6. The shell planter of claim 5 wherein:
said shell planter body stand-off feature is a platform;
said platform including a planar portion and a depending sidewall; and
said platform sidewall extending between said shell planter body base member planar portion and said platform planar portion.

7. The shell planter of claim 6 wherein:
said shell planter body sidewall includes a watering aperture; and
said shell planter body sidewall watering aperture disposed above said platform.

8. A planter assembly comprising:
a grower planter, said grower planter including an upper distal end;
a shell planter, said shell planter including an upper distal end;
said shell planter structured to enclose said grower planter; and
wherein, when said grower planter is disposed in said shell planter, said grower planter distal end is disposed subjacent to said shell planter distal end.

9. The planter assembly of claim 8 wherein, when said grower planter is disposed in said shell planter, said grower planter distal end is disposed proximately subjacent to said shell planter distal end.

10. The planter assembly of claim 8 wherein, when said grower planter is disposed in said shell planter, said grower planter distal end is disposed immediately subjacent to said shell planter distal end.

11. The planter assembly of claim 8 wherein:
said grower planter including a body with a base member and an upwardly depending sidewall;
said grower planter body defining an enclosed space;
said grower planter body sidewall including a distal end;
said shell planter including a body with a base member and an upwardly depending sidewall;
said shell planter body sidewall including a distal end;
said shell planter body structured to enclose said grower planter body;
wherein, when said grower planter body is disposed in said shell planter body, said grower planter body sidewall distal end is disposed subjacent to said shell planter body sidewall distal end;
said grower planter body disposed in said shell planter body; and
wherein said grower planter body sidewall distal end is disposed subjacent to said shell planter body sidewall distal end.

12. The planter assembly of claim 11 wherein:
said grower planter body sidewall is tapered wherein said grower planter body sidewall distal end has a maximum cross-sectional area;
said shell planter body sidewall is tapered, wherein said shell planter body sidewall distal end has a, subjacent, inner surface; and
wherein said shell planter body sidewall distal end subjacent, inner surface is sized relative to said grower planter body sidewall distal end maximum cross-sectional area to be one of a corresponding size, a closely corresponding size, or a snuggly corresponding size.

13. The planter assembly of claim 8 wherein:
said shell planter body base member includes a generally planar portion;
said grower planter body base member is generally planar;
one of said shell planter body base member or said grower planter body base member includes a stand-off feature; and
wherein said stand-off feature is structured to space said grower planter body base member above said shell planter body base member.

14. The planter assembly of claim 13 wherein:
said stand-off feature is unitary with said shell planter body;
said shell planter body stand-off feature is a platform;
said platform including a planar portion and a depending sidewall; and
said platform sidewall extending between said shell planter body base member planar portion and said platform planar portion.

15. The planter assembly of claim 14 wherein:
said shell planter body sidewall includes a watering aperture; and
said shell planter body sidewall watering aperture disposed above said platform.

16. The planter assembly of claim 15 wherein said aperture disposed superjacent said platform.

17. The planter assembly of claim 13 wherein:
said grower planter including a body with a base member and an upwardly depending sidewall;
said grower planter body defining an enclosed space;
said stand-off feature is unitary with said grower planter body;
wherein said stand-off feature includes a number of hollow legs extending downwardly from said grower planter base member; and
each said leg including a passage.

18. The planter assembly of claim 17 wherein:
said shell planter body sidewall includes a watering aperture; and
said shell planter body sidewall watering aperture disposed above said grower planter base member.

19. The planter assembly of claim 18 wherein said aperture disposed superjacent said grower planter base member.
